(19) United States
(12) Patent Application Publication
(10) Pub. No.: US 2007/0061958 A1
(43) Pub. Date: Mar. 22, 2007

(54) Boiler

(76) Inventor: Shengyu Ye, Zhejiang (CN)

Correspondence Address: LADAS & PARRY, 26 WEST 61ST STREET, NEW YORK, NY, 10023, US

(21) Appl. No.: 10/564,701

(22) PCT Filed: Jul. 13, 2004
(86) PCT No.: PCT/CN04/00798

§ 371 Date: Jul. 11, 2006

(30) Foreign Application Priority Data
Jul. 13, 2003 (CN) 03147391.1
May 3, 2004 (CN) 200410038864.9

(51) Int. Cl. A61H 33/06

(52) U.S. Cl. 4/524

(57) ABSTRACT

The present invention relates to a sauna bathroom. At present, a commercial sauna bathroom is generally provided with apparatus both for shower-bath and pool-bath. With plenty of hot water drained in vain, a sauna bathroom is often gloomy and damp. To take a bath at home, no matter it is a tub bath, a shower bath or a shower bath using a water heater, often involves high costs and is cold in cold weather. For a shower bathroom type or suspended sauna bathroom or a commercial sauna bathroom with steam, there is only one outlet for the steam to enter into the sauna bathroom, thus forming a steam column rising upward after the steam comes out off the outlet. Therefore, the upper part is too hot and stuffy, while at the lower part it is cold. In order to overcome the above-mentioned various difficulties, the present invention involves a plurality of outlets provided around the lower end of the bathroom for steam entering into different types of sauna bathrooms. Means for supplying the fresh air or hot air is arranged in the same height as of a washbasin so that a user does not feel stuffy in the bathroom. The present invention also provides a minisize sauna bathroom and enables wet sauna to be offered as the only way of bathing in a commercial sauna bathroom into which hot water, hot air and steam are supplied.

### FIELD OF INVENTION

The present invention relates to a bathroom, in particular, to a sauna bathroom.

### BACKGROUND ART

At present, a commercial sauna bathroom is generally provided with apparatus both for shower-bath and pool-bath. Due to hot water used in shower-bath and pool-bath and heating purpose, plenty of hot water is drained in vain involving huge water consumption. Further, a sauna bathroom is so stuffy, gloom and damp that bacteria are easy to propagate. As reported by the media, someone even caught pneumonia due to going to the sauna bathroom frequently. A popular sauna bathroom is difficult to sustain because of high water costs and high petroleum costs (for heating water). Moreover, it takes at least RMB one hundred thousand to build a bathroom. Other factors, such as a large area, a high boiler and difficulties in finding a suitable place, make a commercial sauna bathroom even harder to develop and popularize which may have certain undesirable impact on public sanitation and health care. Thus it can be seen that a commercial sauna bathroom needs to be upgraded. In addition, to take a bath at home, no matter it is a tub bath, a shower bath or a shower bath using a water heater, often involves high costs and is cold. Besides, a bathroom is usually very damp and not easy to dry. A sauna chamber has passed away because it is difficult to clean. As to a suspended sauna bathroom in a shower bathroom (with steam), there is only one outlet for the steam to enter into the sauna bathroom, thus forming a steam column rising upward after the steam comes out off the outlet. The steam column reaches the roof first, and then pushes down slowly. Therefore, the upper part is too hot and stuffy, while at the lower part it is nothing but cold air. A user often feels rather cold inside further because the connection between the lower part and the ground is not tight which allows cold air to enter into the bathroom from the lower end. Obviously, it is difficult to enjoy sauna at home. At present, a commercial sauna bathroom uses a large volume of hot air for its bathroom and rest room. Hot air which is normally produced by air conditioners involves huge costs for electricity. Neither a suspended sauna bathroom nor a minisize sauna bathroom is provided with automatic water supply at present, and the steam generator equipped to a shower bathroom, which is introduced from abroad, is inconvenient to regulate the steam temperature with high steam pressure and expensive price.

### SUMMARY OF THE INVENTION

In order to overcome the disadvantages and difficulties of a commercial sauna bathroom and in order to solve the problem of taking bath at home, the present invention provides a commercial sauna bathroom, of which water consumption is small and which does not cause air pollution and is energy-efficient for heating water and of which, the bathroom is spacious and not too damp to grow bacteria. Since hot air is produced with coal for such a sauna bathroom, the cost is reduced significantly. The present invention also provides a home-used sauna bathroom which is economic, warm and sanitary.

The technical solution to resolve the above problems is:

1. A boiler a: consists of a boiler casing, a boiler chamber and a boiler bottom, in which water is filled between the boiler casing and the boiler chamber, and of which the lower part is a boiler cavity and the upper part is an air duct, briquettes (honeycomb briquettes) being filled in the boiler cavity and the boiler cavity having on one side an opening, through which the briquettes are filled into the boiler cavity one by one in a transverse direction.

A boiler b: is a combination of a boiler and a hot wind stove, of which an outer layer is a boiler with upper and lower segments, the boiler cavity being located under the center of the boiler, the opening for filling briquettes being on one transverse side of the boiler cavity and a heat exchanger being on top of the boiler cavity, the heat exchanger being communicated with a blower fan used to transport air, one side of the heat exchanger being used to pass flame, the other side being used to pass air, flame and air not mixing each other and on top of the heat exchanger being a chimney.

2. A sauna bathroom:

A. A minisize sauna bathroom: comprises an airtight wall and an airtight roof having an opening for stretching out a user's head, the roof and the opening being connected by a funnel made of thin and soft material with the ground or the like acting as the roof. The hot water and steam or hot air is provided from outside when the bathroom is being used. There is a door for the user to enter into or come out of the bathroom, A bag for containing clothing is attached to the wall. Or the bath tub can be used as the bottom of the minisize sauna bathroom. A drainer connecting a pipe is provided on the bottom of the bath tub. The wall of bath tub is connected to the wall of the sauna bathroom tightly so that air cannot flow between inside and outside. The wall of the sauna bathroom is disposed on the edges of the bath tub without any connection between them. Alternatively, a shape of bath tub made of soft and watertight material fits over the bottom of the minisize sauna bathroom to act as the bottom of the bathroom having a drainer connecting a pipe. A stool, allowing sitting on three sides, with different sizes of length, width and height, is provided in the room.

B. Manner of suspension of the suspended sauna bathroom: Around the roof are arranged 8 or more hooks, through which the sauna bathroom is suspended on a horizontal frame. The lower end of the bathroom wall is connected with the bottom thereof tightly so that there is no air communication between the lower end of the bathroom and the outside. A plurality of inlets of fresh air or hot air are arranged around the lower end thereof. On the air inlet is provided an air blower, of which the wind direction is changeable and which delivers hot air or fresh air toward a user's cheek. A shape of bath tub made of soft and watertight material fits over the lower end of the suspended sauna bathroom having a drainer connecting a pipe. A bag for containing clothing is attached to the wall.

C. A shower type sauna bathroom: comprises a plurality of inlets of steam or hot air around the lower end thereof. On the air inlet is provided an air blower, of which the wind direction is changeable and which delivers hot air or fresh air toward a user's cheek. A closet for containing clothing is provided on the wall.

D. A steam generator provided for a minisize, a suspended or a shower type sauna bathroom is a small boiler contained in a water tank with a cover shared by the tank and the boiler.

E. Automatic water supply device for the steam generator:

(1) An open end of a blind stub pipe is arranged in an outer wall of the water tank of the steam generator or of another vessel, a blind end of the stub pipe being arranged in the water tank. A dry reed pipe is arranged in the stub pipe on which there is a frame. An electric magnetic floater floating up or down is arranged in the frame. A circuit of the dry reed pipe is connected to a solenoid valve.

(2) A butt end of a pipe of a vent room in a counter flooding valve (patent No.: 86205855) is contained in a cylindrical vessel and a water outlet pipe of the counter flooding valve is also connected into the vessel, The vessel is communicated with the water tank of the steam generator or another vessel through a communicating pipe.

F. Around a lower end of a commercial sauna bathroom (the sauna bathroom per se) there are a steam or hot air inlet a hot water inlet for shower, an air blower which is used for delivering hot air and fresh air to a user's cheek and of which the wind direction is changeable.

G. A commercial sauna bathroom is equipped with different kinds of sauna bathrooms offering sauna bath only for customers. Briquettes are filled into a briquette boiler of a boiler cavity one by one transversely. Heat is supplied by using a combination of a boiler and a hot wind stove. A water-heating system includes a pipe at an upper end of a water tank of the boiler which directs hot water upward into a hot water tank at high position and a pipe which directs cool water in the hot water tank to flow back to the water tank of the boiler and to which a tap water pipe is connected. Valves are installed onto three pipes at connection points. The boiler, the water tank at high position and the sauna bathroom are all disposed on the same floor. A meter is connected to the pipe for hot water supply.

The beneficial effects of the present invention are as follows: the hot water boiler burns briquettes, which is not pollutant and more economical than petroleum. With briquettes filled into the boiler one by one transversely, the structure involved is advanced with a larger heat-transfer area. As a result, compared with conventional briquette-burning boiler with the same size, it can heat much more water in a same period of time. With water drums surrounding the boiler fire, thermal efficiency is high. Additionally, the price of this kind of boiler is cheap and large quantities of fiends can be saved.

The advantages of the combination of a boiler and a hot wind stove are as follows: an air conditioner turns the heat energy of coal into steam by heating water, the steam then drives a steam turbine to generate electricity, which is used to drive a compressor to create heat energy to hear air. The heat energy of coal is used to heat air after many steps involving a great deal of energy losses and huge human and material resources consumption so that the cost is high. The combination of a boiler and a hot wind stove turns the heat energy of coal into hot air directly through a heat exchanger, thus reducing expenses significantly and saving electrical energy.

The structure of a minisize sauna bathroom is quite simple which allows quite convenient cleaning. It can be seen from the embodiment of the present invention that it can be washed through turning it outside in, or it can be washed just like clothing by taking off the surrounding room wall and roof from the room frame. As the sauna bathroom occupies a small space, it becomes hot immediately after being filled with hot air. As a user's head is outside the sauna bathroom, the user does not feel stuffy even if the room is much hotter (an average user prefers hotter sauna bath), which is in particular good for the weak or the old who are likely to become faint in extremely hot and stuffy environment. When a bath tub with a drainer connecting a pipe at its bottom acts as the bottom of a minisize sauna bathroom, waste water is drained through the pipe, the minisize sauna bathroom then can be installed anywhere which enables a sauna bathroom to be installed in a home with a rather small toilet. Additionally, a stool with an appropriate height can be selected as required, which is very convenient.

With a bag attached to the wall for containing clothing, a user can enter the sauna bathroom with dressing on before taking a bath and come out of it with dressing on again after taking the bath. Such a sauna bathroom (including suspended, shower bathroom type and minisize ones) can be used anywhere, even on for a trial on the site of selling.

The roof of a suspended sauna bathroom is suspended on the frame with 8 or more hooks. With so many hooks used, the roof can spread out as great as possible; the space inside the bathroom is then enlarged to the greatest extent with the wall surrounding the roof.

A suspended, a shower bathroom type or a commercial sauna bathroom (the sauna bathroom per se) which is heated with steam, each has an inlet of steam or hot air at the lower end thereof so that the steam or hot air combines with the cold air at the lower part. With the lower part thereof sealed from the outside tightly, the hot air does not go up too quickly, since if so, the lower part would become vacuum. With the steam or hot air entering into the lower part continuously, the lower part becomes very hot and therefore the upper part becomes hot naturally. For a sauna bathroom of the shower bathroom type, it is dry and sanitary so far as there is hot air. A user does not feel stuffy with an air blower delivering hot air or fresh air to the user's cheek and with changeable wind direction. Unlike the shower bath and pool bath requiring plenty of hot water for heating purpose, a sauna bathroom according to the present invention, which can save lots of hot water, only consumes from one tenth to one twentieth of hot water used by a shower bath or a tub bath. A sauna bathroom according to the present invention provided with a steam generator offers sauna bath with steam, which is better and feels hotter than a dry sauna. The user can have a cleaner bath and feel more comfortable etc.

The steam generator has a simple structure and costs low. Equipped with automatic water supply, it has better performance and is convenient in use.

Automatic water supply with a dry reed pipe and a solenoid valve is simple and convenient. With a counter flooding valve, automatic water supply is not influenced by water temperature, which is safe and reliable.

Hot water, hot wind and steam of a commercial sauna bathroom is supplied by burning briquettes, thereby decreasing the cost and pollution significantly, compared with combusting petroleum. A sauna bathroom instead of a shower bath or a pool bath means sanitary and comfortable bathing environment instead of gloomy, damp and bacteria-growing environment preventing plenty of hot water from being drained in vain. A water meter is connected to the hot-water pipe enabling charging by the volume of water used, which is in favor of water saving. Taking a sauna bath is more comfortable and cleaner than taking a shower bath or a tub bath. Hot water circulating between the boiler water tank and the hot water tank at high position eliminates the step of sending hot water in the water drum of the boiler into the water pump of the hot water tank at high position thereby increasing effective volume of the water tank of the boiler. Water in the water drum of the boiler becomes hot so that water in the water tank at high position becomes hot. Large volume of hot water enables convenient operation. Since a sauna bathroom consumes less water, it can have a smaller boiler and a smaller hot water tank at high position so that the sauna bathroom, the boiler and the water tank at high position can be installed at the same floor, thereby lowering the requirements of installing a sauna bathroom on a house.

### BRIEF DISCRIPITON OF THE DRAWINGS

FIG. 1 is a schematic diagram of an embodiment of a hot water boiler a (briquette-burning boiler) according to the present invention, including a boiler casing 1, a vent duct 2, a boiler cavity 3, briquettes 4, a boiler bottom 5, a grate 6, a boiler cavity mouth 7, a boiler cavity door, and a briquette clamp 9 with a bent head.

FIG. 2 is a schematic diagram of an embodiment of the combination of a boiler and a hot wind stove, including an upper segment 1 of the boiler of an outer layer of the combination, a heat exchanger of arrayed pipes, refractory material 9 at the connection between the upper and lower segments of the combination, an lower segment 5 of the boiler of an outer layer of the combination, briquettes 4, a grate 6, a boiler cavity 3, an opening 7 of the boiler cavity, a blower fan 8 and a chimney 10.

FIG. 3 is a schematic diagram showing an embodiment of a minisize sauna bathroom according to the present invention, including a funnel 1, an opening 2, a wall 3, a frame 4, a zipper bag opening 5,6, a zipper door opening 7, a bag 8, a stool 9 and a roof 10.

FIGS. 4A and 4B is a schematic diagram showing an embodiment of a shower type and a suspended sauna bathroom using steam and hot air according to the present invention, including a roof 1, a wall 2, a bottom 3, a hot air inlet 4, a steam, hot air pipe 5, a door 6, a fresh air or hot air inlet 7 and gas outlet 8.

FIG. 4C is a schematic diagram of a suspended sauna bathroom, including a frame 9, a hook 10 and a roof 11.

FIG. 5 is a schematic diagram showing a heating system of a commercial sauna bathroom according to the present invention, including a water tank at high position 1, a pipe 2 for directing hot water in the water drum of the boiler upward to the water tank at high position, a shower pipe 3, a spray cup 4, a water drum of the boiler 5, a tap water pipe 6, a circulating pipe 7 and a valve 8, a valve 9, a tap water pipe 10, a valve 11 and a valve 12.

FIG. 6: A: is an assembly diagram showing a counter flooding valve for automatic water supply system, a cylindrical vessel and a steam generator, including an air chamber 1, a counter flooding valve and a valve rod 2, a valve body 3, a water pipe 4 for directing water of the counter flooding valve into the cylindrical vessel, an air pipe 5 with one end connected to the air chamber and the other end being a butt, a communicating pipe 6 between the cylindrical vessel and the steam generator, a cylinder vessel 7 and water level 8.

B: is a structural diagram showing an automatic water supply of the steam generator and the solenoid valve for the water tank, including a frame 9, a floater 10, a magnet 11, a blind head stub pipe 12, a dry reed pipe 13, a boiler 14, an electric heating tube 15, a pinhole 16, a circuit 17, a solenoid valve 18, a cover 19 and a water tank 20.

### PREFERRED EMBODIMENTS

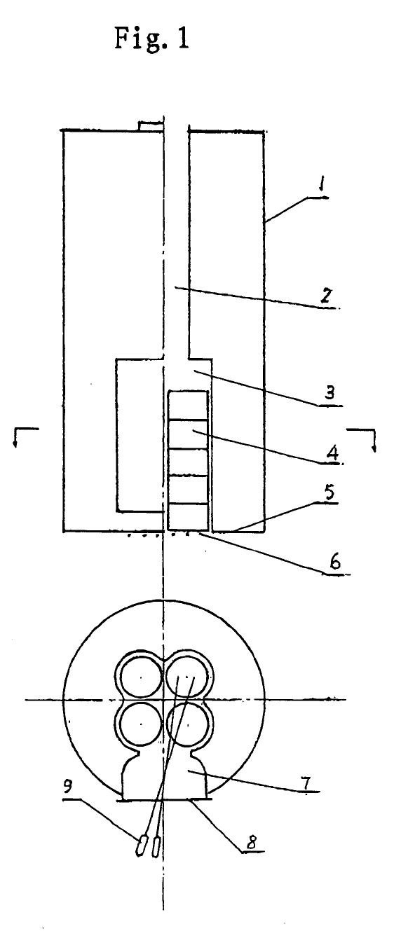

FIG. 1: A boiler cavity 3, a vent duct 2, a boiler bottom 5 and a boiler cavity opening are assembled before forming a boiler with a boiler casing. The method for filling the briquette 4 into the boiler cavity 7 is as follows: a briquette clamp 9 with a bent head clamps the briquette transversely and fills it transversely into a boiler cavity from its opening. To align a specific hole of a briquette (briquettes are mold-made so that the position of hole has the mark) with the specific mark in the boiler cavity and then with the position of the following briquette, so that all the holes in the briquette are in alignment up and down.

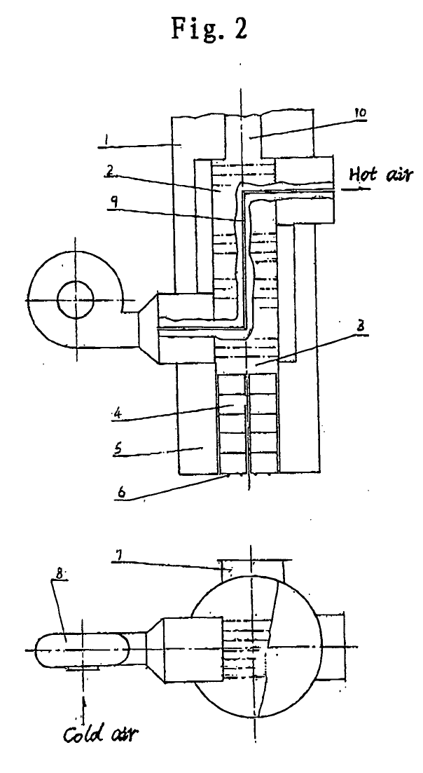

FIG. 2: First, the lower segment 5 of the outer layer of the boiler is put in place. At the center of the lower segment is the boiler cavity and on which the arrayed-tube heat exchanger is provided and supported on the lower segment thereof; second, the boiler upper segment 1 and the blower fan 8 are put in place; finally, the seam 9 between the upper segment and the lower segment is filled with refractory material.

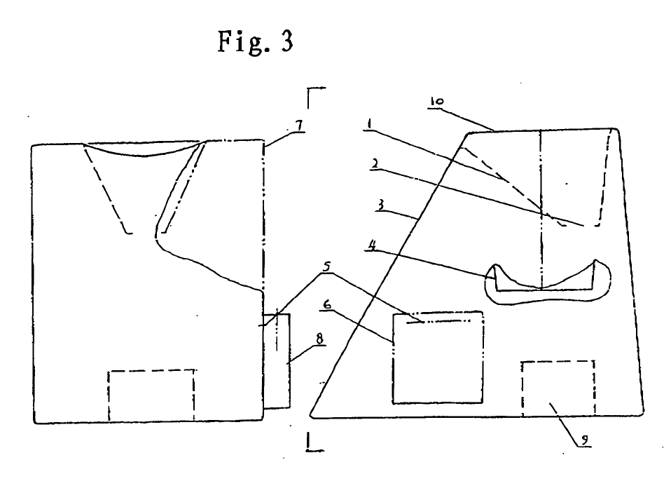

FIG. 3: After the frame 4 is mounted, thin and soft material is used to wrap over the frame 4 to define the wall 3 and the roof 10. A funnel 1, made of thin and soft material is provided in the middle of the roof 10 to allow a user's free movement in all directions having an opening 2 thereon for stretching out the user's head. Then, a wall 3, a frame 4, a zipper opening 7 for going in/out of the bathroom, a bag opening zipper 5 for putting in clothing from inside the bathroom, a bag opening zipper 6 for taking out clothing from outside the bathroom, a bag 8 and a stool 9, with different sizes for length, width and height and which allows sitting on all the sides are provided.

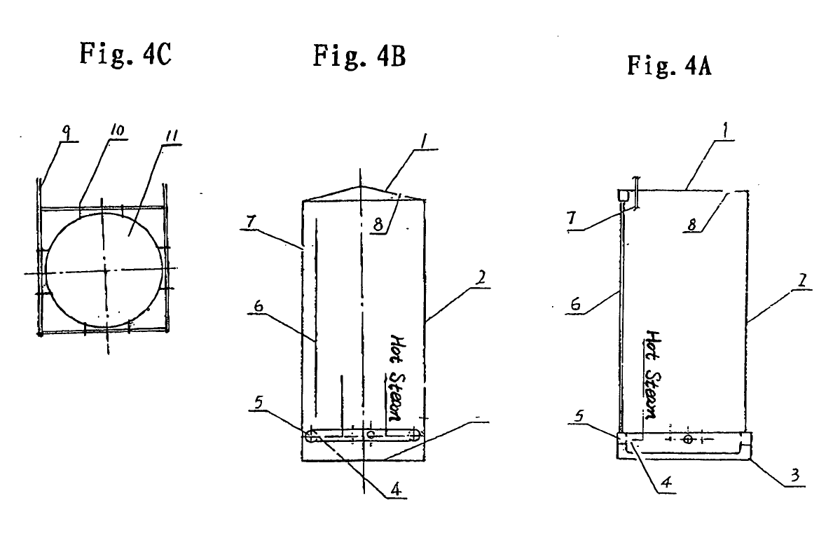

FIG. 4A: The door 6 is made of glass. A plurality of steam or hot-blast outlets 4 for the steam or warm-air pipe 5 are arranged inside the bathroom. The steam or hot air pipes 5 are arranged on the bottom 3 forming a circle below the door and the wall. The steam or hot air from the pipe combines the cold air at the lower part of the bathroom so that the cold air becomes hot. An air exit 8 is also arranged.

FIG. 4B: The door 6 is opened or closed by a zipper. An airtight wall 2 made of silk coated with glue has a lower end thereof connected to the bottom 3 tightly so as to separate the inside from the outside cold air. An air-suction inlet 7 is opened in the wall 2; the exhaust outlet 8 is opened in the roof 1; a steam or hot-air pipe 5 having a plurality of steam or hot air outlets 4 opening toward the center of the bathroom, is arranged around the lower end thereof.

FIG. 4C: A frame is fixed on the wall or roof. Eight hooks suspended on the frame are evenly distributed around the roof of the suspended sauna bathroom so that the roof can spread out as great as possible. With wall surrounding the roof, the internal space of the bathroom is enlarged to the greatest extent.

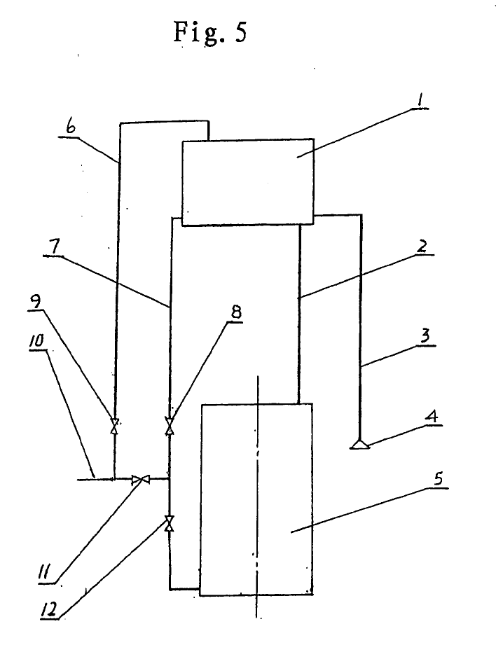

FIG. 5: Shutting off a valve 8 before opening a valve 11 and a valve 1 to have a water drum 5 of the boiler filled with water. There is a small quantity of water in the water tank at high position. Shut off the valve 11. Open the valve 8 when burning water so that the water in the water drum and water tank begins circulating. After the water is heated, open the valve 11 to pressurize the hot water in the water drum of the boiler into the water tank at high position while the water in the water drum is cool which should be kept on being heated. When the water in the water tank gets too hot, the temperature of spaying water can be lowered through opening the valve 8. The temperature of the water in the hot water tank at high position can be lowered entirely through opening the valve 9.

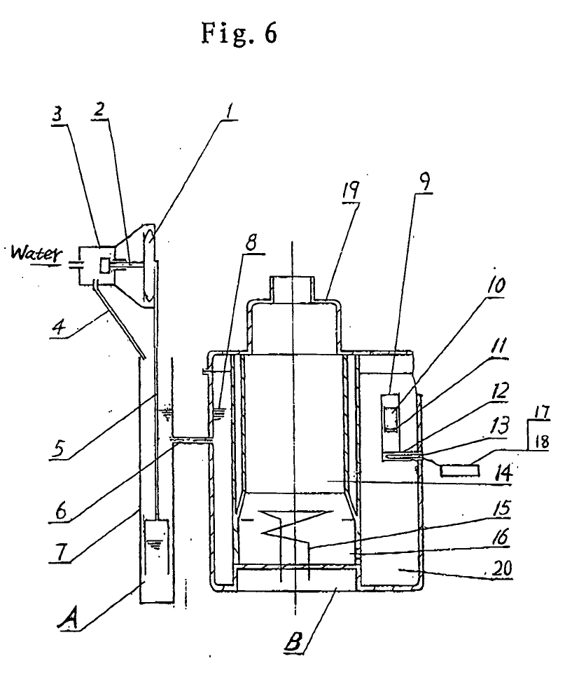

FIG. 6: A: Water enters into the counter flooding valve and flows into the cylindrical vessel 7 before entering the butt end of the air pipe 5 so as to pressurize air into the air chamber. With air pressurized in, the air chamber 1 gets enlarged to drive the valve rod 2 to shut off. The cylindrical vessel and the water tank of the steam generator is communicated with each other by a communicating pipe 6.

B: When the water in the water tank of the steam generator becomes shallow, the magnet 11 of the floater 10 is in close contact with the dry reed pipe 13 to connect the circuit 17 of the dry reed pipe so that the solenoid valve is power-on. Open the valve 18 to allow water to flow in to fill the water tank so that the floater 10 goes up and the magnet 111 goes away from the dry reed pipe 13 to break off the circuit therein thereby closing the valve and the water is stopped.

What is claimed is:

1. A boiler burning honeycomb briquettes, characterized in that the boiler comprises a boiler casing (1), a boiler chamber and a boiler bottom (6), in which water is filled between the boiler casing (1) and the boiler chamber, the lower part of the boiler chamber being a boiler cavity (3), the upper part thereof is an air duct (2), and briquettes (honeycomb briquettes) (4) are filled in the boiler cavity (3), on one side of which there is an opening (7), through which the briquettes (4) are filled into the boiler cavity (3) one by one transversely.

2. A combination of a boiler and a hot wind stove, characterized in that an outer layer thereof is a boiler comprising upper and lower segments, the boiler cavity is located under the center of the boiler, an opening (7) for filling in briquettes is disposed on one transverse side of the boiler cavity on top of which a heat exchanger is disposed, the heat exchanger being communicated with a blower fan used to transport air with one side thereof used to pass flame and the other side used to pass air, flame and air so that they do not mix each other, on the top of the heat exchanger being a chimney.

3. A minisize sauna bathroom, characterized in comprising an airtight wall (3) and a roof (10) having an opening (2) for stretching out a user's head, the roof (10) and the opening (2) being connected by a funnel made of thin and soft material, the ground or the like acting as the bottom, the hot water and steam or hot air being supplied from outside when in use, and a door (7) for the user to enter into or come out of the bathroom.

4. The minisize sauna bathroom as claimed in claim 3, characterized in that a bag (8) for containing clothing is attached to the wall (3).

5. The minisize sauna bathroom as claimed in claim 3, characterized in that a shape of bath tub made of soft and watertight material fits over the lower part of the minisize sauna bathroom to function as the bottom of the minisize sauna bathroom having a drainer connecting a pipe.

6. The minisize sauna bathroom as claimed in claim 3, characterized in that the bath tub is used as the bottom of the minisize sauna bathroom, a drainer connecting a pipe is arranged on the bottom of the bath tub, the wall of bath tub is connected to the wall of the sauna bathroom tightly so that air does not flow between inside and outside, the wall of the sauna bathroom is located on the wall of the bath tub, without any connection between them.

7. The minisize sauna bathroom as claimed in claim 3, characterized in that a stool which allows sitting on three sides and with different sizes for length, width and height, is arranged in the room.

8. A suspended sauna bathroom surrounded with thin and soft material, characterized in that around the roof 8 or more hooks are provided, through which the sauna bathroom is suspended on a horizontal frame, the lower end of the bathroom wall (2) is connected with the bottom (3) thereof tightly so that there is no air communication between the lower end of the bathroom and outside, a plurality of inlets of steam or hot air are arranged around the lower end thereof.

9. The suspended sauna bathroom as claimed in claim 8, characterized in that on the air inlet (7) is arranged an air blower, of which wind direction is changeable and which delivers hot air or fresh air toward the user's cheek.

10. The suspended sauna bathroom as claimed in claim 8, characterized in that a shape of bath tub made of soft and watertight material fits over the lower end of the lift type sauna bathroom to function as the bottom of the suspended sauna bathroom having a drainer connecting a pipe.

11. The suspended sauna bathroom as claimed in claim 8, characterized in that a bag for containing clothing is provided on the wall.

12. A shower type sauna bathroom, including a glass door forming half of the wall, inlets of steam or hot air and outlets of air on the top thereof, characterized in that a plurality of inlets of steam or hot air are arranged around the lower end thereof.

13. The shower type sauna bathroom as claimed in claim 12, characterized in that on the air inlet (7) is arranged an air blower, of which wind direction is changeable and which delivers hot air or fresh air toward the user's cheek.

14. The shower type sauna bathroom as claimed in claim 8, characterized in that a closet for containing clothing is arranged on the wall.

15. A steam generator used for a minisize, a suspended or a shower type sauna bathroom, characterized in that a small boiler is arranged in a water tank which uses the same cover of the water tank.

16. An Automatic water supply device for the tank of the steam generator as claimed in claim 15 or another vessel, characterized in that an open end of a blind stub pipe is arranged in the outer wall of the water tank, a blind end of the stub pipe is arranged in the water tank, a dry reed pipe is arranged in the stub pipe on which there is a frame, a circuit of the dry reed pipe is connected to the solenoid valve and a magnet floater floating up or down is arranged in the frame.

17. The Automatic water supply device for the tank of the steam generator as claimed in claim 15 or another vessel, characterized in that a butt end of a pipe of a vent room in a counter flooding valve is contained in a cylindrical vessel, an outlet pipe of the counter flooding valve is also connected into the vessel, the vessel being communicated with the water tank of the steam generator.

18. A commercial sauna bathroom (sauna bathroom per se) which comprises a cabin, including a steam inlet, characterized in that around the lower end thereof are steam or hot air inlet and hot water inlet for a shower.

19. The commercial sauna bathroom as claimed in claim 18, characterized in that there is an air blower, of which wind direction is changeable and which delivers hot air or fresh air toward the user's cheek.

20. A commercial sauna bathroom, supplied with hot water and steam, characterized in that the commercial sauna bathroom is equipped with different kinds of sauna bathrooms all offering sauna bath as the only way of bathing.

21. The commercial sauna bathroom as claimed in claim 20, characterized in that the boiler is a briquette-burning boiler to the cavity of which briquettes are filled into one by one transversely and heat is supplied by using a combination of a boiler and a hot wind stove.

22. The commercial sauna bathroom as claimed in claim 20, characterized in that a water meter is connected to the pipe supplying hot water.

23. The commercial sauna bathroom as claimed in claim 20, characterized in that on an upper end of a water drum of the boiler there is a pipe directing hot water upward into a hot water tank at high position, and a pipe directing cool water in the hot water tank to flow back to a lower end of the water drum of the boiler which is connected to a tap water pipe, valves being installed onto three pipes at connection points.

24. The commercial sauna bathroom as claimed in claim 20, characterized in that the boiler burning blind coal, the water tank in high position and the sauna bathroom are all installed on the same floor.
